(19) United States
(12) Patent Application Publication
(10) Pub. No.: US 2006/0198763 A1
(43) Pub. Date: Sep. 7, 2006

(54) Influenza virus harvester

(76) Inventors: Qi Dang, Union City, CA (US); Richard Schwartz, San Mateo, CA (US)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 11/363,290

(22) Filed: Feb. 23, 2006

Related U.S. Application Data
(60) Provisional application No. 60/657,450, filed on Mar. 1, 2005.

(51) Int. Cl. B01L 3/02

(52) U.S. Cl. 422/100

(57) ABSTRACT

The present invention is directed to a harvester of influenza virus from fertilized chicken eggs in a continuous manner comprising a control panel, a connector having three openings, a pipette, a peristaltic pump, and a sample reservoir. In another embodiment, the harvester comprises a pipette gun having a retrieving button and an aspiration button instead of the control panel. The present invention is also directed to a method of harvesting the influenza virus using the pipette gun.

### CROSS-REFERENCE TO RELATED APPLICATION

The present application claims the benefit under 35 U.S.C. §119 (e) of U.S. provisional application Ser. No.60/657,450, filed on Mar. 1, 2005, the disclosure of which is incorporated herein in its entirety by reference.

### BACKGROUND

This invention relates generally to a liquid transfer and handling device, and particularly to a harvester that collects influenza virus from fertilized chicken eggs in a continuous mode. This invention also relates to a method of harvesting the influenza virus from the chicken eggs in an ergonomic manner.

Influenza, or flu, is a respiratory infection that has a worldwide impact in the fall and winter seasons. The flu can spread quickly and suddenly from a local community to a broader region. The flu can be life threatening to elderly people, newborn babies and people with chronic illness. In the United States, an estimated 100,000 people are hospitalized each year due to the flu infection, and about 36,000 people die due to the flu or flu-related complications. See Flu Fact Sheet, National Institute of Allergy and Infectious Diseases, available at www.niaid.nih.gov/factsheets/flu.htm. The influenza virus is transmitted primarily by air, but can also be spread through contacting a surface that has been contaminated by someone who has the flu.

Influenza, or flu, is a respiratory infection that has a worldwide impact in the fall and winter seasons. The flu can spread quickly and suddenly from a local community to a broader region. The flu can be life threatening to elderly people, newborn babies and people with chronic illness. In the United States, an estimated 100,000 people are hospitalized each year due to the flu infection, and about 36,000 people die due to the flu or flu-related complications. See Flu Fact Sheet, National Institute of Allergy and Infectious Diseases, available at www.niaid.nih.gov/factsheets/flu.htm. The influenza virus is transmitted primarily by air, but can also be spread through contacting a surface that has been contaminated by someone who has the flu.

The principal preventive measure against the influenza virus is to obtain the influenza vaccine before the flu season begins. Because there are many different strains of the flu virus, the flu vaccine must be prepared afresh every year against the particular strains of the flu that are affecting the population. See Influenza Vaccine Production Fact Sheet, at www.upmc-biosecurity.org/misc/flu/vaccine.html. In each January, the World Health Organization. (WHO) Global Influenza Surveillance Network, the Food and Drug Administration (FDA) and the Center for Disease Control (CDC) share their information and make recommendations on the strains of the flu that should be chosen for flu vaccine production. Usually, three different strains of the flu virus are used for the preparation of the flu vaccine: two influenza A viruses and one influenza B virus.

The use of avian eggs, typically chicken eggs, as the means of incubation has been an integral part of flu vaccine production, including life-attenuated flu vaccine, for a number of years. Fertilized chicken eggs are chosen from healthy flocks of hens and grown for about 12 days. The seeds of one of the three strains of the flu virus are injected and incubated inside the fertilized chicken eggs for about 2 to 3 days. Afterwards, the allantoic fluid is removed from the eggs by aspiration. The flu virus is purified and chemically inactivated in order to prevent it from becoming contagious. Flu virus of each of the three strains of the flu virus is broken into fragments and then mixed with the other two strains to form a flu vaccine that contains three strains of the flu virus. The manufacturing of the flu vaccine must be carried out in compliance with the guideline established by the FDA. See Guidance for Industry, available at http://www.fda.gov/cber/gdlns/cmcvacc.pdf.

At the present time, eggs are generally harvested by two methods. First, in a high volume environment eggs are placed on trays carried by a conveyor belt. Typically, all the eggs on one tray are harvested at the same time. The harvested liquids include allantoic fluid, albumen, yolk and sometimes blood. The harvested liquids are then separated and washed to isolate the allantoic fluid. On the other hand, allantoic fluid can be extracted with single pipette in a manual process. Care is typically taken so that no other fluids or contaminants are extracted. Since the volume of the pipette is limited, the operator can usually harvest only one egg at a time. The pipette is emptied between eggs. The manual process can be time consuming, but does not require post-harvested processing steps. The first method is described in “The Flu SNAFU” Time Magazine, pp. 69-73 (Nov. 1, 2004).

Therefore, there remains a need for a harvester that can efficiently harvest materials from eggs in a continuous manner.

### SUMMARY OF THE INVENTION

According to a first aspect of the present invention, an apparatus for harvesting fluid from a plurality of eggs includes a pump, a pipette connected to the pump and adapted to withdraw fluid from the eggs, and a sample reservoir connected to the pump to store the harvested fluids.

According to a second aspect of the present invention, a method of harvesting fluid from a plurality of eggs comprises the steps of (i) making an opening in an egg, (ii) inserting a pipette into the egg, (iii) drawing the fluid into the pipette, (iv) inspecting the fluid, and (v) transferring the fluid to a sample reservoir. Steps (i)-(v) can be performed in a repeated in a continuous manner with multiple eggs.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic drawing of a harvester;

FIG. 2 is a schematic drawing of a second embodiment of a harvester according to the present invention; and

FIG. 3 is a plan view of an egg being harvested with a pipette and a spoon.

### DETAILED DESCRIPTION

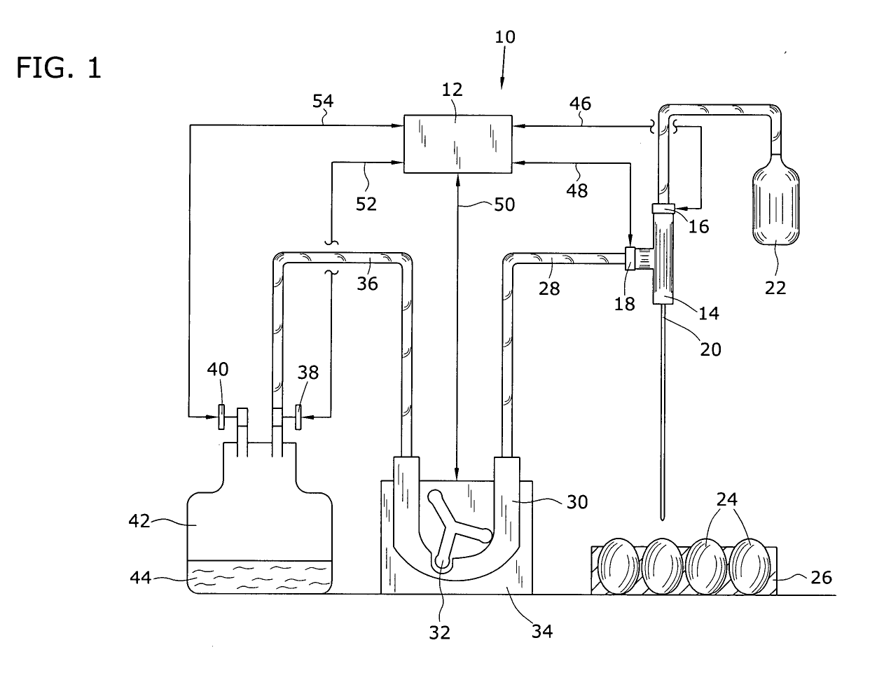

Referring to FIG. 1, a first embodiment of harvester 10 for continuously retrieving and collecting samples of the influenza virus is shown. Harvester 10 includes control panel 12, a pipette 20, a pump 34, a pressure source 22 and a sample reservoir 42. A plurality of eggs 24 can be presented on a tray 26 to the operator of harvester 10. Tray 26 is made of suitable materials such as paper, plastic, Styrofoam, and the like. Tray 26 can also provide a suitable place where the chicken eggs are incubated.

Control panel 12 regulates the operation of harvester 10. Control panel 12 preferably includes a computer processor and a user interface. The computer processor may be any processor known in the art, such as a microchip processor. The processor preferably contains software for regulating the various components of harvester 10. The user interface preferably includes a display screen, such as an LCD screen. The user interface of control panel 12 also preferably includes a user input device such as a keyboard, a mouse, or push buttons connected to switches for inputting information into the processor.

Harvesting is preferably done by pipettes. Preferably, the pipette is operated by a human operator, so that only the allantoic fluid is harvested and contaminants are avoided. By using the control panel 12, the operator can efficiently retrieve the allantoic fluid from the eggs, one egg at a time. Allantoic fluid is transported to pump 34 via nozzle 18, and then to the sample reservoir 42 via connector or valve 38. There is no need for the operator to stop periodically because the sample collection operation is not limited by the holding volume of pipette 10. Efficiency in the collection of samples is therefore improved.

Pump 34 is preferably controlled by control panel 12 via connection 50. For example, pump 34, which provides the suction to harvest allantoic fluid, can be turned on/off or the speed may be adjusted. Pump 34 may be any type of pump known in the art. Preferably, pump 34 is a peristaltic pump. The operation of peristaltic pumps is well-known in the art. These pumps generally consist of a rotor member 32 and a flexible tube 30. Peristaltic pumps create low pressure in tube 30 as rotor member 32 spins and its arms push against the outer walls of flexible tube 30. This periodic compression and release of flexible tube 30 cause fluid in flexible tube 30 to be drawn therethrough. The advantages of using peristaltic pumps are: (a) there is no contamination by the pump of the sample inside the tube, (b) biological samples such as blood and proteins are not damaged by the pump and (c) since flexible tube 30 is generally transparent, contaminants can be visually inspected. A number of peristaltic pumps are suitable for use with the present invention, including a pump using two shoes or rollers, available from Watson-Marlow of Wilmington, Mass.

Pipette 20 may be any pipette known in the art. Pump 34 creates suction within pipette 20 to draw allantoic fluid through pipette 20. Pump 34 is operatively coupled to pipette 20 via tubing 28 and pipette valve or connector 18 located on a connector 14. Pump 34 transfers fluid from pipette 20, through tubing 28, through tubing 36 and into sample reservoir 42. The harvested allantoic fluid is stored as fluid 44 in reservoir 42. Tubing 28 and 36 may be any type of tubing known in the art, such as plastic or rubber tubing. The size of the tubing is generally dictated by the requirements of the pump. In one example, the tubing has an inner diameter of about 6.4 mm. The tubing may have inner diameter in the range of about 4.0 mm to about 10 mm. Optional connectors or valves 38 and 40 control the flow of fluid into and out of sample reservoir 42. These connectors or valves, which may be any type of connectors or valves known in the art, are preferably controlled either manually or by controller 12 via connections 52 and 54, respectively.

Pipette 20 can be a measuring pipette, a volumetric pipette, or a Pasteur pipette. Suitable materials for the pipette 20 can be glass, polyethylene, polypropylene, or polystyrene. Pipette 20 can be marked with graduation and can be recyclable or it can be disposable. Pipette 20 can also be purchased as sterile or non-sterile. Preferably, pipette 20 is disposable and sterile. More preferably, pipette 20 is a sterile, disposable, volumetric pipette having a volume larger than the volume of the allantoic fluid of one egg. Preferably, pipette 20 is transparent for visual inspection. The use of a volumetric pipette allows the operator to visually inspect the allantoic fluid for color and turbidity. If the sample is acceptable, the operator can continue the pumping of the sample to the sample reservoir 42 via the control panel. If the sample is unacceptable due to unusual coloration or unusual turbidity, the operator can stop the sample retrieving process. The operator can eject the unacceptable sample by applying pressure from pressure source 22. Subsequently, the operator may replace the volumetric pipette having been in contact with an unacceptable sample with another sterile disposable volumetric pipette.

Pipette valve 18 may be any type of connector or valve known in the art, such as tubings, canulas, one-way valves, check valves, and poppet valves, among others. Pipette valve 18 is preferably controlled by control panel 12 via a connection 48, which may be a hardwired link or a wireless connection, such as radio frequency.

Connector 14 may be any type of connector known in the art, preferably a T-connector. As shown in FIG. 1, connector 14 is a T-connector with three female ports. Alternatively, connector 14 may be a T-connector with any combination of male and female ports, for example, having male ports to connect to pipette valve 18 and a pressure valve 16 with a female port connected to pipette 20; having female ports to connect to pipette valve 18 and pipette 20 and a male port to connect to pressure valve 16; female ports connected to pipette valve 18 and pressure valve 16 and a male port connected to pipette 20. The size of the main body of connector 14 may be made larger or smaller in length or diameter than shown in FIG. 1, such as to accommodate larger fluid volumes, to speed up or slow down the fluid flow, or to increase or decrease fluid pressure. Connector 14 can also be a Y-shaped connector or a triangular-shaped connector. Connector 14 can also be a manifold with three or more openings. Suitable materials for the connector 14 includes, but are not limited to, glass, polyethylene, polypropylene, polystyrene, rubber, or metal. For ease of inspection, connector 14 is preferred to be a transparent material such as glass, polyethylene, polypropylene, or polystyrene. A plurality of pumps and pipettes can be connected to a single controller 12, and a plurality of pipettes can be connected to a single pump.

Pressure source 22 may be any type of pressure source known in the art, such as hydraulic, pneumatic, or the like and is used to purge liquid from the pipette. Preferably, pressure source 22 is a canister of pressurized gas. The gas can be air, nitrogen, helium, neon, argon, or carbon dioxide.

Pressure source 22 is operatively coupled to pipette 20 via connector 14 and, preferably, a pressure valve 16. Preferably, pressure valve 16 is used to regulate the amount of pressure transferred from pressure source 22 to pipette 20. Pressure valve 16, similar to pipette valve 18, may be any type of valve known in the art, such as a one-way valve, a poppet valve or preferably, a variable flow valve. Valve 16 is controlled by control panel 12 via a connection 46, which may be a hardwired link or a wireless connection, for example, upon visual inspection of the fluid within pipette 20, an operator may decide that the fluid is cloudy, too turbid, or contaminated. By inputting a signal into controller 12, pump 34 may be shut off and pipette valve 18 closed. Pressure valve 16 is opened, thereby transferring pressure from pressure source 22 into pipette 20 and expelling the contents thereof.

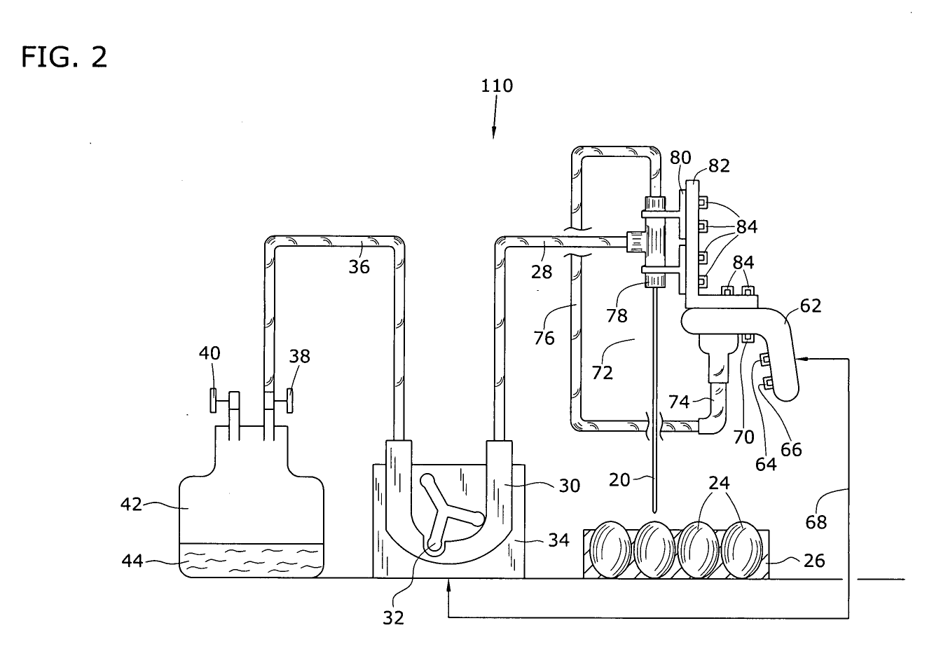

Referring to FIG. 2, a second exemplary embodiment of a harvester 110 that can retrieve and collect samples continuously includes a modified pipette gun 62 with a retrieving button 64 and an aspiration button 66, a pipette 20, a pump 34 and a sample reservoir 42. Pipette 20, pump 34 and sample reservoir 42 are substantially as described above with respect to the first embodiment in structure and function. Pipette gun 62 may be any pipette gun known in the art, such as those available from Brinkmann Instruments, Inc. of Westbury, NY.

In contrast to harvester 10, harvester 110 does not utilize a control panel. Instead, modified pipette gun 62 allows an operator to turn ON or OFF pump 34 using retrieving button 64 which is linked to pump 34 via a connection 68, which is preferably a hard-wired electrical connection. In addition, the operator can use the aspiration button 66 to eject a sample from pipette 20, if necessary. Therefore, modified pipette gun 62 allows the operator to harvest fluid continuously and ergonomically from eggs. Modified pipette gun 62 preferably also includes a release button 70 that facilitates the attachment and detachment of an aspirating cone 72 to and from modified pipette gun 62.

Aspirating cone 72 is connected to pipette 20 via a first connector 78, tubing 76 and an optional second connector 74. For the purpose of illustration, first connector 78 is shown as a T-connector and second connector 74 is shown as an L-shaped connector. As is known in the art, connectors 78, 74 may have many other configurations. For example, in other embodiments of the invention, connector 74 can be an I-shaped connector, an S-shaped connector, or a U-shaped connector. Connector 74 may also be a manifold with at least two openings, or with three openings 78 such as a Y-shaped connector, a triangular-shaped connector, or a manifold with at least three openings. For ease of visual inspection, connectors 74, 78 are preferred to be a transparent material, such as glass, polyethylene, polypropylene, or polystyrene. Materials for tubing 28, 36, and 76 of the present embodiment are similar to those described above for use as tubing 28, 36 of the first embodiment.

Pipette gun 62 is preferably mounted on an L-bracket 82 so that the operator does not need to manually suspend pipette gun 62 during operation. Pipette gun 62 may be mounted by any attachment methods and structures known in the art, such as by an adhesive or screws. Connector 78 is also preferably attached to a pair of snap-in mounting brackets 80, which in turn are anchored to the vertical member of L-shaped bracket 82, also by any attachment structure known in the art, such as with multiple screws 84. Bracket 82 provides the ergonometric arrangement for the operator between gun 62 and pipette 20. Preferably, bracket 82 contains at least a ninety-degree turn, e.g., the corner in the L-bracket. Bracket 82 can have a turn ranging from about 60° to about 300° turn. Bracket 82 may be made from a single piece, as shown in FIG. 2, or can be made from multiple pieces that are operatively connected together.

Similar to the first embodiment discussed above, a plurality of eggs 24 can be presented on a tray 26 to the operator. The operator precisely inserts pipette 20 into an opened egg 24. By pressing retrieving button 64, pump 34 is activated, providing suction for drawing fluid such as allantoic fluid 44 into pipette 20. Bracket 82 allows pipette 20 to be mounted in the proximity of modified pipette gun 62 so that the operator can visually examine the sample that is being retrieved from the eggs. In case the operator decides to reject a sample, the operator can release retrieving button 64, and press aspiration button 66 to eject the sample from the pipette. If the sample drawn from egg 24 is acceptable, then the operator simply continues depressing retrieving button 64 so that pump 34 may transfer fluid 44 to sample reservoir 42. Therefore, the operator can harvest the influenza virus from the chicken eggs continuously in an efficient and ergonomic manner. The arrangement of pipette gun 62, T-shaped connector 78 and L-shaped bracket 62 constitute the ergonomics of harvester 110.

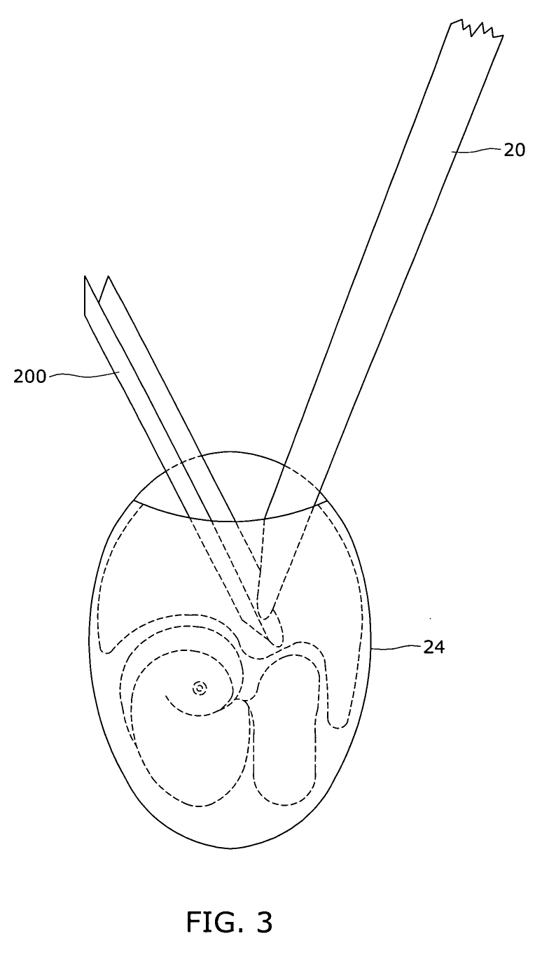

Referring to FIG. 3, spoon or separator 200 can be used with pipette 20 to harvest allantoic fluid. Spoon 200, as shown, comprises a surface curved around its longitudinal axis, and is sized and dimensioned to enter the allantoic cavity and to push aside the yolk sac and the amniotic cavity, which contains the partially formed embryo. After the egg is cut open, spoon 200 breaks the membrane and moves the embryo aside. Spoon 200 also pushes the feathers and any other undesirable objects away from pipette 20 to minimize the chance of harvesting these objects along with the allantoic fluid. Spoon 200 can have other shapes and can be perforated. Spoon 200 may comprise a mesh or strainer to separate the allantoic fluid from the undesirable objects.

Harvester 110 of the present invention is capable of harvesting about 800 ml of allantoic fluid, which represents the recoverable allantoic fluid in about 90 eggs, in about 9 minutes, or about 88.9 ml/min. Preferably, the harvesting rate is at least 70 ml/min, preferably at least 80 ml/min and more preferably at least 90 ml/min. This represents a marked improvement over the manual single pipette technique described above, which can harvest about 800 ml in about 16 minutes or about 50 ml/min.

Also, harvester 110 is capable of sustaining a flow rate in the range from about 250 ml of allantoic fluid per minute to about 500 ml per minute. Hence, a single harvester can be coupled to a plurality of pipettes. In one embodiment, harvester 10, 110 is connected to a manifold, which is connected to a plurality of pipettes 20.

Additionally, while the embodiments of the present inventions are described with respect to harvesting allantoic fluid in avian eggs, harvester 10, 110 can be used in other applications, including but not limited to, transporting and handling biological fluids (e.g., amniotic fluids, cell culture medium), vaccines, pharmaceuticals, laboratory liquids, among others. Harvester 10, 110 can also be used in cell culture.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). For example, an automated visual inspection system including a digital camera can be utilized in both embodiments. Such inspection system can be connected to controller 12. The camera is calibrated and can acquire a digital image of the harvested fluid at any convenient location upstream of reservoir 42. The acquired image is compared against a standard or master image. If the color of the harvested liquid is “darker” or otherwise different from the color of the standard image by more than a predetermined amount, then controller 12 signals the operator or the controller. Therefore, it will be understood that the appended claims are intended to cover all such modifications and embodiments, which would come within the spirit and scope of the present invention

We claim:

1. An apparatus for harvesting fluid from a plurality of eggs comprising:
a pump;
a pipette connected to the pump and adapted to withdraw fluid from the plurality of eggs; and
a sample reservoir connected to the pump to store the withdrawn fluid from the plurality of eggs.

2. The apparatus of claim 1, wherein the pipette is a disposable pipette.

3. The apparatus of claim 1, wherein the pipette is a volumetric pipette.

4. The apparatus of claim 1, wherein the pipette is a disposable volumetric pipette.

5. The apparatus of claim 1, wherein the pump is a peristaltic pump.

6. The apparatus of claim 1 further comprising a first valve disposed between the pump and the pipette.

7. The apparatus of claim 6 further comprising a second valve disposed between the pump and the sample reservoir.

8. The apparatus of claim 7 further comprising a control panel operatively connected to the pump.

9. The apparatus of claim 8, wherein the control panel is also operatively connected to at least one of the first valve and the second valve.

10. The apparatus of claim 8 further comprising a pressure source operatively connected to the control panel and the pipette, wherein the pressure source can expel any contents disposed within the pipette.

11. The apparatus of claim 10, wherein the pressure source is a canister of pressurized gas.

12. The apparatus of claim 11, wherein the gas is selected from the group consisting of air, nitrogen, helium, neon, argon and carbon dioxide.

13. The apparatus of claim 10 further comprising a pressure valve operatively connected to the pressure source and the control panel, wherein the pressure valve controls the amount of pressure transferred from the pressure means to the pipette.

14. The apparatus of claim 1 further comprising a pipette gun configured to be operatively connected to the pipette and the pump.

15. The apparatus of claim 14, wherein the pipette gun comprises a retrieving button and an aspiration button.

16. The apparatus of claim 14, wherein the pipette gun comprises an aspirating cone, and wherein a tube connects the aspirating cone and the pipette.

17. The apparatus of claim 14, wherein a bracket connects the pipette to the pipette gun to improve the ergonometry of the operation of the pipette.

18. The apparatus of claim 17, wherein the bracket comprises a turn ranging from about from about 60° to about 300° .

19. The apparatus of claim 18, wherein the bracket comprises a turn of about 90° .

20. The apparatus of claim 1 further comprising a separator, wherein the separator cooperates with the pipette to minimize the inclusion of undesirable objects in the withdrawn fluid.

21. The apparatus of claim 20, wherein the separator comprises a spoon.

22. The apparatus of claim 20, wherein the separator comprises a surface curved around the separator's longitudinal axis.

23. The apparatus of claim 20, wherein the separator is perforated.

24. The apparatus of claim 20, wherein the separator comprises a screen.

25. The apparatus of claim 1, wherein the apparatus is capable of harvesting fluid from the plurality of eggs at least about 70 ml/min.

26. The apparatus of claim 25, wherein the apparatus is capable of harvesting fluid from the plurality of eggs at least about 80 ml/min.

27. The apparatus of claim 26, wherein the apparatus is capable of harvesting fluid from the plurality of eggs at least about 90 ml/min.

28. The apparatus of claim 1, wherein the pipette is transparent.

29. An apparatus for harvesting biological fluid comprising:
a pump;
a pipette connected to the pump and adapted to withdraw the biological fluid; and
a collection reservoir connected to the pump to store the withdrawn biological fluid.

30. The apparatus of claim 29, wherein the biological fluid comprises allantoic fluid, amniotic fluid, vaccine, pharmaceutical fluid or laboratory fluid.

31. A method of harvesting fluid from a plurality of eggs comprising the steps of:
(i) making an opening in an egg;
(ii) inserting a pipette into the egg;
(iii) drawing the fluid into the pipette;
(iv) inspecting the fluid; and
(v) transferring the fluid to a sample reservoir, wherein steps (i)-(v) can be performed in a continuous manner with multiple eggs.

32. The method of claim 31, further comprising step (vi) rejecting the fluid.
